(19) United States
(12) Patent Application Publication
(10) Pub. No.: US 2008/0037564 A1
(43) Pub. Date: Feb. 14, 2008

(54) NETWORK DEVICE AND METHOD FOR STARTING V5 CONNECTION THEREOF

(75) Inventor: CHU-FENG LIEN, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/736,589

(22) Filed: Apr. 18, 2007

(30) Foreign Application Priority Data
Apr. 28, 2006 (TW) 95115299

(51) Int. Cl. H04L 12/28; H04L 12/50; H04Q 3/00

(52) U.S. Cl. 370/401; 370/217; 379/219

(57) ABSTRACT

An access node connected to a local exchange is provided, the access node including a V5 interface, a first timer and a first detection module. The V5 interface starts a V5 connection between the access node and the local exchange. The first timer times according to a first timing period if the V5 connection is started, and comprises a first timing-detection sub-module. The first detection module detects whether the access node receives variant and interface ID information within the first timing period. The first timing-detection sub-module detects whether the first timer times out if the access node does not receive the variant and interface ID information. A method for starting V5 connection is also disclosed.

### BACKGROUND OF THE INVENTION

1. Field of the Invention

The invention generally relates to a network device and a method thereof, and particularly to an access node and a method for starting a V5 connection thereof.

2. Description of Related Art

Open interfaces (V5.1 and V5.2) between an access node and a local exchange are defined in the European Telecommunications and Standards Institute (ETSI) standards. V5 interfaces enable subscribers belonging to a physically separate, wired or wireless access network to be connected using a standard interface of a telephone exchange.

If the access node or the local exchange fails, the V5 connection therebetween needs to be restarted. However, since the access node and the local exchange operate at different frequencies, restart synchronization may not be possible, and thus restart of the V5 connection may be unsuccessful.

### SUMMARY OF THE INVENTION

An access node connected to a local exchange is provided, the access node including a V5 interface, a first timer, and a first detection module. The V5 interface starts a V5 connection attempt between the access node and the local exchange. The first timer times according to a first timing period if the V5 connection attempt is started, and comprises a first timing-detection sub-module. The first detection module detects whether the access node receives variant and interface ID information within the first timing period. The first timing-detection sub-module detects whether the first timer times out if the access node does not receive the variant and interface ID information.

A method for starting a V5 connection is also provided, the method including: providing a first timer; starting the V5 connection attempt; starting the first timer to time according to a first timing period; detecting whether the access node receives variant and interface ID information within the first timing period; detecting whether the first timer times out if the access node does not receive the variant and interface ID information; detecting whether the V5 connection attempt is successful if the first timer does not time out; and stopping the first timer if the V5 connection is successful.

Other advantages and novel features will become more apparent from the following detailed description of preferred embodiments when taken in conjunction with the accompanying drawings, in which:

### BRIEF DESCRIPTION OF THE DRAWINGS

FIG. 1 is a diagram illustrating an application environment of an access node of an exemplary embodiment of the invention;

FIG. 2 is a block diagram of the access node of an exemplary embodiment of the invention;

FIG. 3 is a flowchart of a method for starting a V5 connection of another exemplary embodiment of the invention; and

FIG. 4 is a flowchart of steps following node A of FIG. 3.

### DETAILED DESCRIPTION OF THE INVENTION

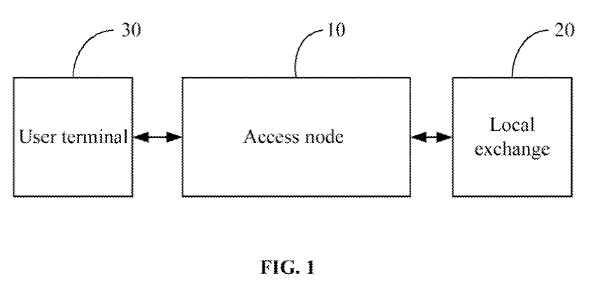

FIG. 1 is a diagram illustrating an application environment of an access node of an exemplary embodiment of the invention. A user terminal 30 is connected to a local exchange 20 via an access node 10. The connection between the local exchange 20 and the access node 10 is a V5 connection.

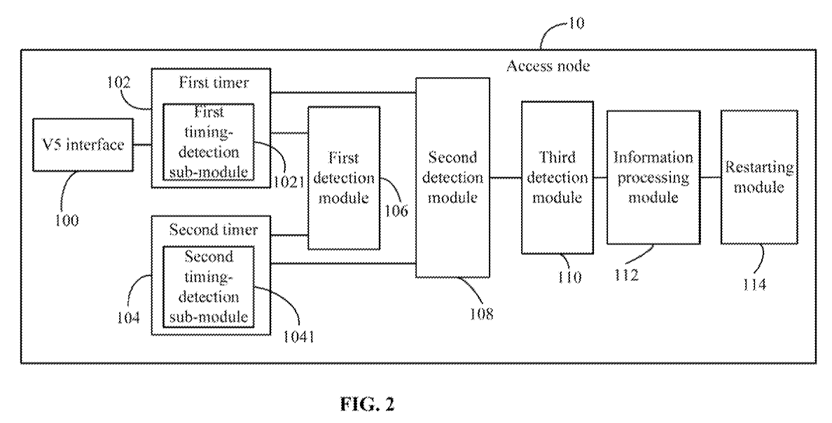

FIG. 2 is a block diagram of the access node 10 of an exemplary embodiment of the invention.

The access node 10 includes a V5 interface 100, a first timer 102, a second timer 104, a first detection module 106, a second detection module 108, a third detection module 110, an information processing module 112, and a restarting module 114.

The V5 interface 100 starts the V5 connection attempt between the access node 10 and the local exchange 20.

The first timer 102 times according to a first timing period if the V5 connection attempt is made, and includes a first timing-detection sub-module 1021 for detecting whether the first timer 102 times out. In this embodiment, the first timing period is 190 seconds.

The second timer 104 times according to a second timing period, and includes a second timing-detection sub-module 1041 for detecting whether the second timer 104 times out. In this embodiment, the second timing period is 30 seconds.

The first detection module 106 detects whether the access node 10 receives variant and interface ID (VID) information if the first timer 102 is started.

The first detection module 106 further detects whether the V5 connection attempt between the access node 10 and the local exchange 20 is successful within the first timing period or the second timing period. In this embodiment, the first detection module 106 detects whether the V5 connection attempt between the access node 10 and the local exchange 20 is successful by checking whether the access node 10 receives unblock-all-ports-complete information.

The second detection module 108 detects whether the connection between the access node 10 and the local exchange 20 is normal if the first timer 102 or the second timer 104 times out.

The third detection module 110 detects whether the access node 10 transmits unblock-all-ports (UBA) information to the local exchange 20 if the connection between the access node 10 and the local exchange 20 is normal.

The information processing module 112 transmits information according to a detection result of the third detection module 110. In this embodiment, if the third detection module 110 detects the access node 10 does not transmit the UBA information to the local exchange 20, the information processing module 112 generates the UBA information, and transmits the UBA information to the local exchange 20. If the third detection module 110 detects the access node 10 transmits the UBA information to the local exchange 20, the information processing module 112 generates restart request information, and transmits the restart request information to the local exchange 20.

The restarting module 114 restarts the first timer 102 or the second timer 104. In this embodiment, if an event of detecting the connection between the access node 10 and the local exchange 20 is normal is triggered by the first timer 102, the restarting module 114 restarts the first timer. Otherwise, the restarting module 114 restarts the second timer 104.

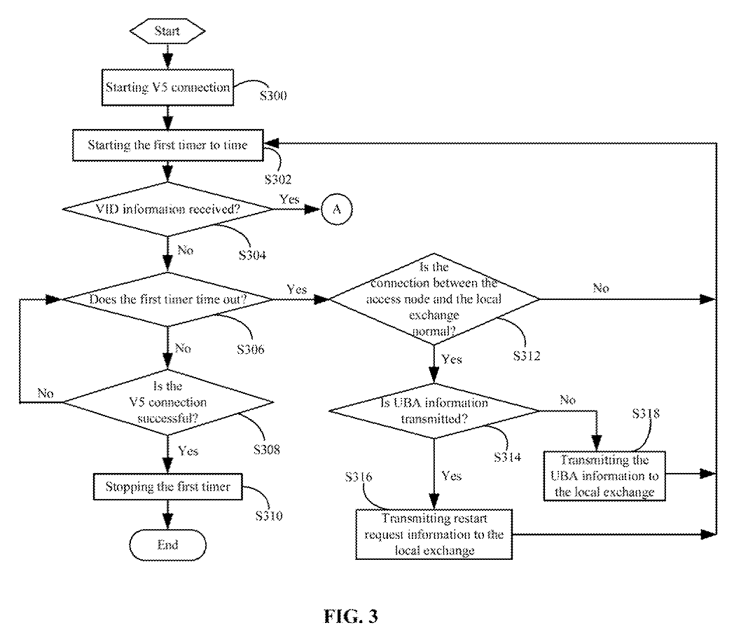

FIG. 3 is a flowchart of a method for starting a V5 connection of another exemplary embodiment of the invention.

In step S300, the V5 interface 100 starts a connection attempt between the access node 10 and the local exchange 20.

In step S302, the first timer 102 times according to a first timing period. In this embodiment, the first timing period is 190 seconds.

In step S304, the first detection module 106 detects whether the access node 10 receives variant and interface ID (VID) information. If the access node 10 does not receive the VID information, the process proceeds to step S306, otherwise the process proceeds to node A.

In step S306, the first timing-detection sub-module 1021 detects whether the first timer 102 times out. If the first timer 102 has not timed out, the process proceeds to step S308, otherwise the process proceeds to step S312.

In step S308, the first detection module 106 detects whether the V5 connection between the access node 10 and the local exchange 20 is successful. In this embodiment, the first detection module 106 detects whether the V5 connection between the access node 10 and the local exchange 20 is successful by checking whether the access node 10 receives unblock-all-ports-complete information.

If the V5 connection between the access node 10 and the local exchange 20 is successful, the process proceeds to step S310, otherwise the process returns to step S306.

In step S310, the first timer 102 stops timing.

In step S312, the second detection module 108 detects whether the connection between the access node 10 and the local exchange 20 is normal. If the connection between the access node 10 and the local exchange 20 is normal, the process proceeds to step S314, otherwise the process returns to step S302.

In step S314, the third detection module 110 detects whether the access node 10 transmits unblock-all-ports (UBA) information to the local exchange 20. If the access node 10 transmits the UBA information to the local exchange 20, the process proceeds to step S316, otherwise the process proceeds to step S318.

In step S316, the information processing module 112 generates restart request information, and transmits the restart request information to the local exchange 20.

In step S318, the information processing module 112 transmits the UBA information to the local exchange 20.

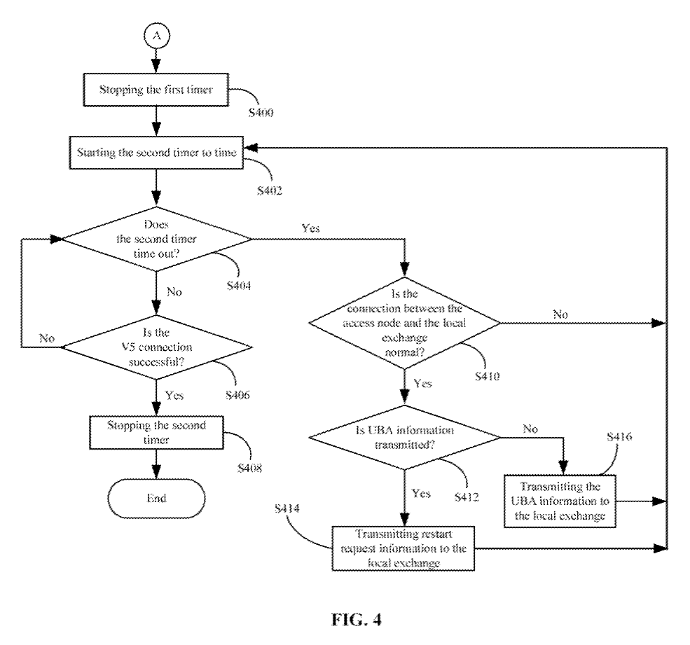

FIG. 4 is a flowchart of steps following node A of FIG. 3.

In step S400, the first timer 102 stops timing.

In step S402, the second timer 104 begins timing according to a second timing period. In this embodiment, the second timing period is 30 seconds.

In step S404, the second timing-detection sub-module 1041 detects whether the second timer 104 times out. If the second timer 104 has not timed out, the process proceeds to step S406, otherwise the process proceeds to step S410.

In step S406, the first detection module 106 detects whether the V5 connection between the access node 10 and the local exchange 20 is successful. In this embodiment, the first detection module 106 detects whether the V5 connection between the access node 10 and the local exchange 20 is successful by checking whether the access node 10 receives unblock-all-ports-complete information.

If the V5 connection between the access node 10 and the local exchange 20 is successful, the process proceeds to step S408, otherwise the process returns to step S404.

In step S408, the second timer 104 stops timing.

In step S410, the second detection module 108 detects whether the connection between the access node 10 and the local exchange 20 is normal. If the connection between the access node 10 and the local exchange 20 is normal, the process proceeds to step S412, otherwise the process returns to step S404.

In step S412, the third detection module 110 detects whether the access node 10 transmits unblock-all-ports (UBA) information to the local exchange 20. If the access node 10 transmits the UBA information to the local exchange 20, the process proceeds to step S414, otherwise the process proceeds to step S416.

In step S414, the information processing module 112 generates restart request information, and transmits the restart request information to the local exchange 20.

In step S416, the information processing module 112 transmits the UBA information to the local exchange 20.

While embodiments and methods of the present invention have been described above, it should be understood that they have been presented by way of example only and not by way of limitation. Thus the breadth and scope of the present invention should not be limited by the above-described exemplary embodiments, but should be defined only of the following claims and their equivalents.

What is claimed is:

1. An access node connected to a local exchange, comprising:
a V5 interface for starting a V5 connection between the access node and the local exchange;
a first timer for timing according to a first timing period if the V5 connection attempt is started, the first timer comprising a first timing-detection sub-module; and
a first detection module for detecting whether the access node receives variant and interface ID information within the first timing period;
wherein the first timing-detection sub-module is for detecting whether the first timer times out if the access node does not receive the variant and interface ID information.

2. The access node in accordance with claim 1, further comprising a second timer for timing according to a second timing period if the access node receives the variant and interface ID information.

3. The access node in accordance with claim 2, wherein the second timer comprises a second timing-detection sub-module for detecting whether the second timer times out.

4. The access node in accordance with claim 3, wherein the first detection module is further for detecting whether the V5 connection is successful within the second timing period.

5. The access node in accordance with claim 4, further comprising a second detection module for detecting whether connection between the access node and the local exchange is normal if the first timer or the second timer times out.

6. The access node in accordance with claim 5, further comprising a third detection module for detecting whether the access node transmits unblock-all-ports information to the local exchange if the connection between the access node and the local exchange is normal.

7. The access node in accordance with claim 6, further comprising an information processing module for transmitting restart request information to the local exchange if the access node transmits the unblock-all-ports information thereto.

8. The access node in accordance with claim 7, wherein the information processing module is further for transmitting the unblock-all-ports information to the local exchange if the access node does not transmit the unblock-all-ports information thereto.

9. The access node in accordance with claim 7, further comprising a restarting module for restarting the first timer if an event of detecting whether the connection between the access node and the local exchange is normal is triggered by the first timer.

10. The access node in accordance with claim 9, wherein the restarting module is further for restarting the second timer if the event of detecting whether the connection between the access node and the local exchange is normal is triggered by the second timer.

11. A method for starting a V5 connection, the method applicable to an access node connected to a local exchange, and comprising:
providing a first timer;
starting the V5 connection;
starting the first timer to time according to a first timing period;
detecting whether the access node receives variant and interface ID information within the first timing period;
detecting whether the first timer times out if the access node does not receive the variant and interface ID information;
detecting whether the V5 connection is successful if the first timer does not time out; and
stopping the first timer if the V5 connection is successful.

12. The method in accordance with claim 11, further comprising:
stopping the first timer if the access node receives the variant and interface ID information; and
starting a second timer to time according to a second timing period.

13. The method in accordance with claim 12, further comprising:
detecting whether the second timer times out;
detecting whether the V5 connection is successful if the second timer does not time out; and
stopping the second timer if the V5 connection is successful.

14. The method in accordance with claim 13, further comprising:
detecting whether the connection between the access node and the local exchange is normal if the second timer times out;
detecting whether the access node transmits unblock-all-ports information to the local exchange if the connection between the access node and the local exchange is normal;
restarting restart request information to the local exchange if the access node transmits the unblock-all-ports information thereto; and
restarting the second timer.

15. The method in accordance with claim 14, further comprising transmitting the unblock-all-ports information to the local exchange if the access node does not transmit the unblock-all-ports information thereto.

16. The method in accordance with claim 15, further comprising restarting the second timer if the connection between the access node and the local exchange is abnormal.

17. The method in accordance with claim 11, further comprising:
detecting whether the connection between the access node and the local exchange is normal if the first timer times out;
detecting whether the access node transmits the unblock-all-ports information to the local exchange if the access node and the local exchange is normal;
transmitting the restart request information to the local exchange if the access node transmits the unblock-all-ports information thereto; and
restarting the first timer.

18. The method in accordance with claim 17, further comprising restarting the first timer if the connection between the access node and the local exchange is abnormal.

19. A method comprising steps of:
starting a V5 connection data-communicable between an access node and a local exchange;
timing a first timing period by a first timer after said V5 connection is started;
detecting whether said access node receives variant and interface ID (VID) information within said first timing period;
detecting whether said V5 connection is successful within said first timing period; and
stopping said first timer when a selective one of a first situation that said VID information is received by said access node within said first timing period and a second situation that said V5 connection is successful within said first timing period happens.

20. The method in accordance with claim 19, further comprising a step of timing a second timing period different from said first timing period by a second timer when said VID information is received by said access node within said first timing period and said first timer is stopped, and a following step of detecting whether said V5 connection is successful within said second timing period to decide to stop said second timer.
